(19) United States
(12) Patent Application Publication
(10) Pub. No.: US 2006/0089180 A1
(43) Pub. Date: Apr. 27, 2006

(54) Mobile communication terminal

(76) Inventor: Ari J. Salmi, Oulu (FI)

Correspondence Address: PERMAN & GREEN, 425 POST ROAD, FAIRFIELD, CT, 06824, US

(21) Appl. No.: 10/971,411

(22) Filed: Oct. 22, 2004

(51) Int. Cl. H04B 7/00

(52) U.S. Cl. 455/575.1; 455/90.2

(57) ABSTRACT

A mobile terminal has means for providing push-to-talk functionality, a volume control member, and a controller associated with the volume control member. The controller is adapted to cause a change in an acoustic output level of the mobile terminal in response to a user actuation of said volume control member. The controller is further adapted to determine whether a duration of said user actuation exceeds a predetermined time period and, in response to said duration exceeding said predetermined time period, to generate a control signal to said means for providing push-to-talk functionality.

### BACKGROUND OF THE INVENTION

1. Field of the Invention

The present invention generally relates to mobile telecommunication and more particularly to a mobile terminal that has a speech-related functionality. Even more particularly, the invention relates to control of push-to-talk functionality in a mobile terminal.

2. Background of the Invention

Mobile terminals, or mobile (cellular) telephones, for mobile telecommunications systems like GSM, UMTS, D-AMPS and CDMA2000 have been used for many years now. In the older days, mobile terminals were used almost only for circuit-switched speech communication with other mobile terminals or stationary telephones. More recently, the use of modern terminals has been broadened to include not just circuit-switched speech communication, but also various other services and applications such as electronic messaging (e.g. SMS, MMS, email), digital image or video recording, FM radio, music playback, electronic games, calendar/organizer/time planner, word processing, WWW/WAP browser, etc.

A mobile terminal 200 of the prior art is shown in FIG. 2. The mobile terminal 200 has a user interface which typically includes a display 203 and a keypad 204 which includes a set of alpha-numeric (ITU-T type) keys 204a. The user interface also comprises acoustic members for sound input and output. These members typically include a microphone 205 and a speaker 202, and additionally often audio I/O ports in an accessories interface. The speaker 202 normally serves to provide acoustic output in the form of human speech, ring signals, music, etc. The mobile terminal has volume control members which most often are provided in the form of a pair of external control keys 220, 222 for volume up and volume down, i.e. for controlling the sound level of the acoustic output.

As more functionality has been added to mobile terminals, additional input means have been required for controlling the functionality. For instance, modern mobile terminals are often provided, in addition to an ITU-T type keypad, with at least one of the following: call handling keys (Answer/YES and Hangup/NO, labeled 204b in FIG. 2), function keys/soft keys (i.e. keys that have different functions in different contexts), a joystick, a 4/5-way navigation key, or a rotator/jog dial.

Traditionally, there have been other radio systems than cellular circuit-switched ones that also provide voice communication between mobile users. Examples of known two-way radio systems are Land Mobile Radio (LMR), Professional Mobile Radio (PMR) and Family Radio Service (FRS). These systems provide direct one-to-one or one-to-many voice communication over radio in a manner that sometimes is referred to as “Push-To-Talk” (PTT) or “walkie talkie”. More recently, cellular mobile terminals have been introduced which in addition to cellular circuit-switched voice communication (e.g. GSM, NMT, AMPS, D-AMPS, UMTS, CDMA2000) also provide push-to-talk functionality in a form which may be referred to as PoC—“Push-to-talk over Cellular”. As indicated by the name, PoC functionality uses a cellular telecommunication system to perform and deliver the push-to-talk services.

When, during an ongoing PTT session, a user wants to say something, he simply presses a dedicated PTT key 210 on the mobile terminal 200 and starts talking into the microphone 205. The speech thus received is digitized, packetized and transmitted to a remote PTT application server that forwards the speech to the or each other party to the PTT session. When the user has finished speaking, he releases the PTT key 210 and another party may speak instead. Thus, PTT is half-duplex communication; only one person can speak at a time, and the other(s) can only listen during this time. The remote PTT application server dynamically controls which party that currently “has the floor” to broadcast (speak) and which party/parties is/are in a receive (listen) mode.

Using a dedicated (separate) PTT key 210 for controlling a PTT session has a disadvantage in that it adds on to the total number of keys in the user interface. Not only will such a separate PTT key require some additional space and therefore have negative implications for a mobile terminal designer that seeks to meet market demands for miniaturized terminals, but it will also add on to the total component cost for the user interface. Furthermore, a separate PTT key represents yet an additional key that the mobile terminal user must know the meaning and location of.

### SUMMARY OF THE INVENTION

In view of the above, an objective of the invention is to solve or at least reduce the problems discussed above. The present invention particularly seeks to provide improvements to the user interface of a mobile terminal having push-to-talk (PTT) functionality.

In more particular, the present inventor has realized that a separate or dedicated PTT key can be eliminated by instead adding a second functionality to a volume control member, such as a volume-up key or a volume-down key. The second functionality consists in controlling a PTT session, such as “requesting the floor” when the user is about to speak, when the volume control member has been kept actuated for a certain time, e.g. long-press on volume-up key. In other words, a long-press on aforesaid volume key simulates actuation of the dedicated PTT key of prior art terminals. A normal actuation (short-press) on this volume key will serve to control the sound level of acoustic output in the conventional manner.

This is advantageous for several reasons. Not only does the invention solve the problems referred to in the previous section by eliminating the need for a separate, dedicated PTT key, but it also represents a convenient and intuitive way for a user to control PTT functionality. The user already associates the volume key with talking activities (for instance, he is used to actuating the volume key to adjust the speaker or headset output level during an ongoing cellular phone call). Therefore, using the volume key to control PTT functionality will be intuitive. The fact that a conventional PTT key actuation is in fact a long-press operation (the PTT key being kept depressed throughout a current speech spurt), makes the inventive solution even more intuitive.

A further advantage is that the typical position of the volume-up and volume-down keys at a long side surface of the mobile terminal is in fact a very handy position also when using the terminal for PTT functionality. Yet another advantage is that a volume key is seldomly used, compared to many other keys of the user interface. Therefore, the invention makes more efficient use of the volume key, since its periods of non-use will be reduced.

Generally, the above objectives are achieved by the attached independent patent claims.

According to a first aspect of the invention there has been provided a mobile terminal having:

means for providing push-to-talk functionality;

a volume control member; and
a controller associated with said volume control member and adapted to cause a change in an acoustic output level of said mobile terminal in response to a user actuation of said volume control member,
said controller further being adapted to determine whether a duration of said user actuation exceeds a predetermined time period and, in response to said duration exceeding said predetermined time period, to generate a control signal to said means for providing push-to-talk functionality.

Aforesaid controller may be adapted to cause said change in said acoustic output level of said mobile terminal only if said determined duration of said user actuation does not exceed said predetermined time period.

In one embodiment, said means for providing push-to-talk functionality comprises a wireless transceiver operable in accordance with at least one mobile telecommunications standard such as GSM, UMTS, D-AMPS or CDMA2000. Such wireless transceiver may further be operable in a packet-switched communications network such as GPRS. Thus, said means for providing push-to-talk functionality may be adapted for voice communication over a data network based on a protocol for packet-switched communication, such as the Internet Protocol (IP).

Advantageously, the volume control member is one of a volume-up key or a volume-down key located on or at an external surface or an apparatus housing of said mobile terminal. This external surface is conveniently selected as a long-side surface of said apparatus housing, located between a front surface, which during normal use faces towards a user, and a rear surface, which during normal use faces away from said user.

The predetermined time period may preferably by selected in the range between about 100 milliseconds and about 1 second, and may more preferably be selected as about 400 milliseconds.

Said means for providing push-to-talk functionality may be adapted, when receiving said control signal from said controller, to transmit by aforesaid wireless transceiver a request for broadcast status to a remote push-to-talk application server over said packet-switched communications network. Furthermore, said means for providing push-to-talk functionality may be adapted, when receiving said control signal from said controller, to transmit by said wireless transceiver digitized and packetized speech, as received by an acoustic input device such as a microphone, to a remote push-to-talk application server over said packet-switched communications network.

Aforesaid controller may further be adapted to detect when said user actuation of said volume control member ends and, in response, to generate a second control signal to said means for providing push-to-talk functionality. When receiving said second control signal from said controller, said means for providing push-to-talk functionality may be adapted to transmit by said wireless transceiver a request for receive status to said remote push-to-talk application server over said packet-switched communications network. Furthermore, when receiving said second control signal from said controller, said means for providing push-to-talk functionality may be adapted to stop transmitting speech by said wireless transceiver to said remote push-to-talk application server over said packet-switched communications network.

A second aspect of the present invention is a method of controlling a mobile terminal with push-to-talk functionality, the mobile terminal having a volume control member for controlling an acoustic output level of said mobile terminal, the method involving the steps of:

detecting a user's actuation of said volume control member;

determining whether a duration of said actuation exceeds a predetermined time period;

in response to said duration not exceeding said predetermined time period, generating a control signal for controlling said acoustic output level; and

in response to said duration exceeding said predetermined time period, generating a control signal for controlling said push-to-talk functionality.

The second aspect has essentially the same or corresponding features as the first aspect.

A third aspect of the present invention is a mobile terminal having

means for providing speech-related functionality;

a volume control member; and

a controller associated with said volume control member, said controller being adapted to detect a user actuation of said volume control member and to discriminate between at least a first and a second type of said user actuation, and

said controller further being adapted, in case said user actuation is of said first type, to generate a control signal for controlling said means for providing speech-related functionality, and, in case said user actuation is of said second type, to generate a control signal for controlling an acoustic output level of said mobile terminal.

Said controller may be adapted to discriminate between said first and said second type of said user actuation by determining whether or not a duration of said user actuation exceeds a predetermined time period.

In one embodiment, said means for providing speech-related functionality comprises means for providing push-to-talk functionality.

In another embodiment, said means for providing speech-related functionality comprises means for voice-activated dialing (VAD).

Advantageously, said volume control member is one of a volume-up key or a volume-down key.

Still another embodiment comprises first and second volume control members in the form of a volume up key and a volume down key, or vice versa, wherein said means for providing speech-related functionality comprises first means for providing push-to-talk functionality and second means for voice-activated dialing (VAD), and wherein said controller is adapted, in case said user actuation is of said first type and is made through said first volume control member, to generate said control signal for controlling said first means for providing push-to-talk functionality, and, in case said user actuation is of said first type and is made through said second volume control member, to generate said control signal for controlling said second means for voice-activated dialing.

Said means for providing speech-related functionality may comprise a wireless transceiver operable in accordance with at least one mobile telecommunications standard such as GSM, UMTS, D-AMPS or CDMA2000.

A fourth aspect of the present invention is a method of controlling speech-related functionality of a mobile terminal having a volume control member, the method involving the steps of:

detecting a user actuation of said volume control member;

discriminating between at least a first and a second type of said user actuation;

in case said user actuation is of said first type, controlling said speech-related functionality; and

in case said user actuation is of said second type, controlling an acoustic output level of said mobile terminal.

In one embodiment, the method is applied in a mobile terminal comprising first and second volume control members in the form of a volume-up key and a volume-down key, or vice versa, and said speech-related functionality includes push-to-talk functionality as well as voice-activated dialing (VAD) functionality, In this embodiment, the method involves the alternative steps of:

either controlling said push-to-talk functionality, in case said user actuation is of said first type and is made through said first volume control member, or controlling said voice-activated dialing functionality, in case said user actuation is of said first type and is made through said second volume control member.

The fourth aspect has essentially the same or corresponding features as the third aspect.

Other objectives, features and advantages of the present invention will appear from the following detailed disclosure, from the attached dependent claims as well as from the drawings.

Generally, all terms used in the claims are to be interpreted according to their ordinary meaning in the technical field, unless explicitly defined otherwise herein. All references to “a/an/the [element, device, component, means, step, etc]” are to be interpreted openly as referring to at least one instance of said element, device, component, means, step, etc., unless explicitly stated otherwise. The steps of any method disclosed herein do not have to be performed in the exact order disclosed, unless explicitly stated.

### BRIEF DESCRIPTION OF THE DRAWINGS

Embodiments of the present invention will now be described in more detail, reference being made to the enclosed drawings, in which:

FIG. 1 is a schematic illustration of a cellular telecommunication system in which push-to-talk services may be performed between different mobile terminals, as an example of an environment in which the present invention may be applied.

FIG. 2 is a schematic front view illustrating a mobile terminal with push-to-talk functionality according to the prior art.

FIG. 3 is a schematic front view illustrating a mobile terminal with push-to-talk functionality according to an embodiment of the present invention.

FIG. 3a is an enlarged view of a volume control member portion of the mobile terminal shown in FIG. 3.

FIG. 3b illustrates an alternative to FIG. 3a.

FIG. 4 is a schematic block diagram representing an internal component, software and protocol structure of the mobile terminal shown in FIG. 3.

FIG. 5 is a flowchart diagram that illustrates the operation of the mobile terminal shown in FIG. 3 to control push-to-talk functionality by detecting actuation of said volume control member.

### DETAILED DESCRIPTION OF THE INVENTION

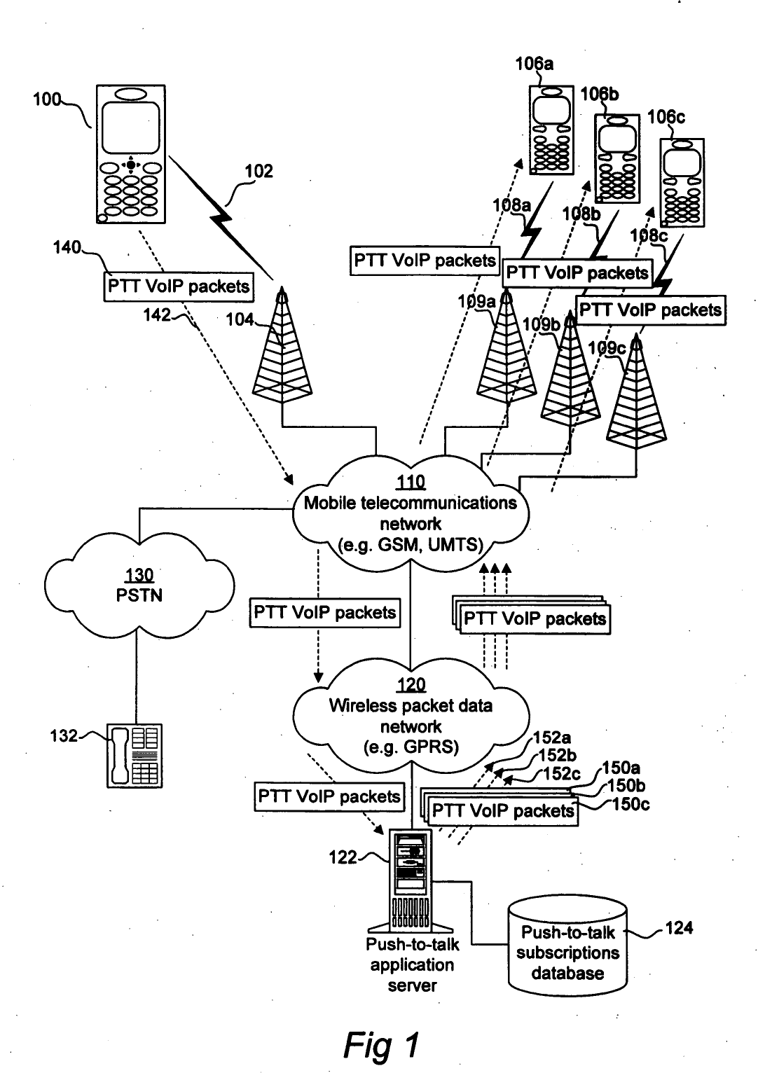

FIG. 1 illustrates one example of a cellular telecommunications system in which the invention may be applied. In the telecommunication system of FIG. 1, various telecommunications services such as cellular voice calls, data calls, facsimile transmissions, music transmissions, still image transmissions, video transmissions, electronic message transmissions and electronic commerce may be performed between a mobile terminal 100 according to the present invention and other devices, such as other mobile terminals 106a-c or a stationary telephone 132. It is to be noticed that for different embodiments of the mobile terminal 100 and in different situations, different ones of the telecommunications services referred to above may or may not be available; the invention is not limited to any particular set of services in this respect.

The mobile terminals 100, 106a-c are connected to a mobile telecommunications network 110 through RF links 102, 108a-c via base stations 104, 109a-c. The mobile telecommunications network 110 may be in compliance with any commercially available mobile telecommunications standard, such as GSM, UMTS, D-AMPS or CDMA2000.

The mobile telecommunications network 110 includes or is operatively connected to a wireless packet data network 120, such as GPRS (General Packet Radio Service). The mobile terminals 100, 106a-c may access various sources available on the Internet through the wireless packet data network 120.

A public switched telephone network (PSTN) 130 is connected to the mobile telecommunications network 110 in a familiar manner. Various telephone terminals, including the stationary telephone 132, are connected to the PSTN 130.

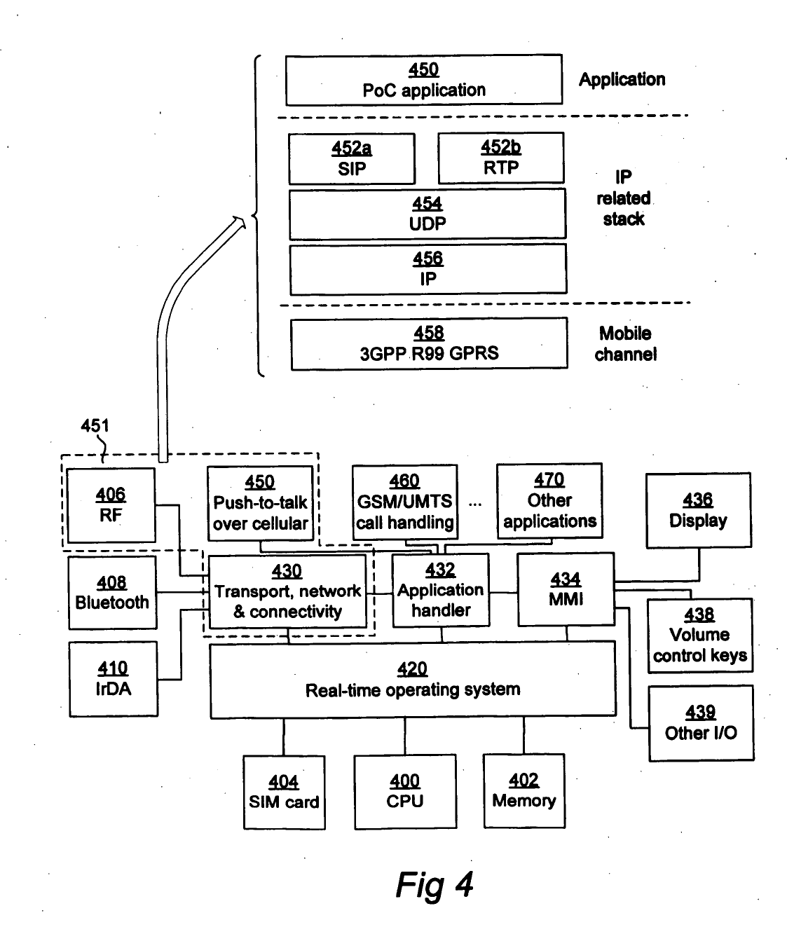

The mobile terminal 100 has push-to-talk (PTT) functionality, as will be described in more detail later, and may thus perform push-to-talk communication with other PTT-enabled mobile terminals 106a-c over mobile telecommunications network 110 and wireless packet data network 120. In the illustrated example of FIG. 1, Push-to-talk over Cellular (PoC) service is implemented as half-duplex Voice over IP (VoIP) based on standard IETF (Internet Engineering Task Force) and 3GPP (Third Generation Partnership Project) protocols via GSM/UMTS network 110 and GPRS network 120. A. PoC protocol stack 451 is illustrated in the block diagram for mobile terminal 100 in FIG. 4. The PoC service of FIG. 1 is based on multi-unicasting; a sending terminal 100 sends packet data traffic, PTT VoIP packets 140, to a dedicated push-to-talk application server 122. In case of a group PoC session, the push-to-talk application server 122 copies the traffic to all recipients/terminals 106a-c, as seen at 150a-c in FIG. 1. This traffic of PTT VoIP packets to, 140, and from, 150a-c, the push-to-talk application server 122 is illustrated as dotted arrows 142 and 152a-c, respectively.

The push-to-talk application server 122 has access to a push-to-talk subscriptions database 124 which may contain subscribing users, their access rights, authentication information, preconfigured group memberships, charging detail-records (CDRs), etc.

Group creation and attachment control are based on the IETF-defined Session Initiation Protocol (SIP) 452a (FIG. 4), and PTT voice traffic is carried out through a Real-time Transport Protocol (RTP, 452b) streaming bearer. Lower-level protocols are User Datagram Protocol (UDP, 454) and Internet Protocol (IP, 456). The low-level mobile channel 458 is formed by 3GPP R99 GPRS.

The illustrated architecture provides real-time voice communication with superior coverage, thanks to the cellular networks 110 and 120, and high resource efficiency (the packet-switched communication will reserve radio and transmission resources only for the duration of PTT talk spurts, instead of for an entire call session as in conventional full-duplex circuit-switched cellular telephony).

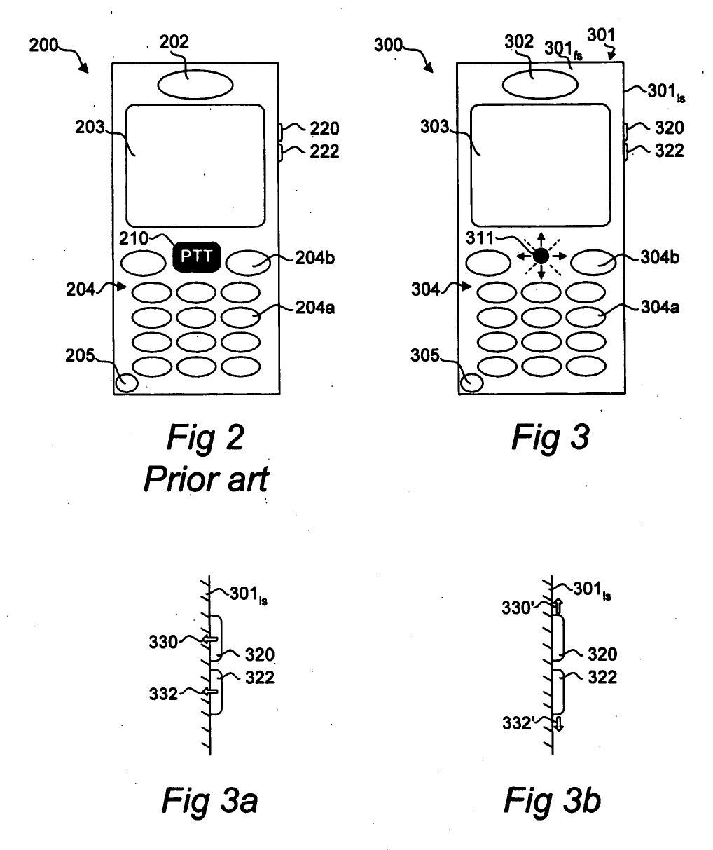

An embodiment 300 of the mobile terminal 100 is illustrated in more detail in FIG. 3. The mobile terminal 300 comprises an apparatus housing 301 with a front surface 301_{fs}, a speaker or earphone 302, a microphone 305, a display 303, and a set of keys 304 which may include a keypad of common ITU-T type (alpha-numerical keypad representing characters “0”-“9”, “*” and “#”) and certain other keys 304b such as soft keys and/or call handling keys. Just like the prior art terminal 200 of FIG. 2, as already mentioned, the mobile terminal 300 has push-to-talk functionality, but it has no dedicated push-to-talk key (like key 210 in the prior art terminal 200 of FIG. 2). Instead, push-to-talk functionality is controlled in this embodiment by actuating the volume-up key 320. Thus, volume-up key 320 has dual functions; it serves as a conventional volume control member for increasing the sound level of the acoustic output through the speaker 302 in any given context (such as call handling, music/media player, electronic game, etc), but in addition to this it serves as the means by which a user may control push-to-talk functionality.

The volume-down key 322 has its conventional function for sound level control; in alternative embodiments it may have an additional purpose for controlling other functionality.

As seen in FIG. 3a, the volume-up key 320 and volume-down key 322 are located at a long-side surface 301ₗₛ of the apparatus housing 301, between the front surface 301_{fs} and a rear surface (not shown). The volume-up key 320, as well as the volume-down key 322, may be actuated by the user by depressing the key in a direction 330, 332 essentially perpendicular to the top of the key 320 and the long side surface 301ₗₛ of the apparatus housing 301. Thus, volume-up key 320 may be resiliently mounted and depressible in the direction 330. Depression of volume-up key 320 is detected by suitable electromechanical, electronic or optical sensor means, as is readily realized by a skilled person. Alternatively, the key 320 may be statically mounted, wherein detection of actuation may be carried out by e.g. electronic (capacitive, piezo-electric) or optical sensor means. The actual design of the volume-up key 320 is not central to the present invention, and nor are the particulars of its sensor means for detection of actuation.

As seen in FIG. 3b, the volume-up key 320, as well as the volume-down key 322, may alternatively be actuated in directions 330′, 332′ which are parallel to the top of the keys and the long side surface 301ₗₛ, i.e. the keys 320, 322 may be slidably displaceable along a short portion of the long side surface 301ₗₛ. Advantageously, the keys are resiliently biased so that they will return to their initial positions when the actuation ends.

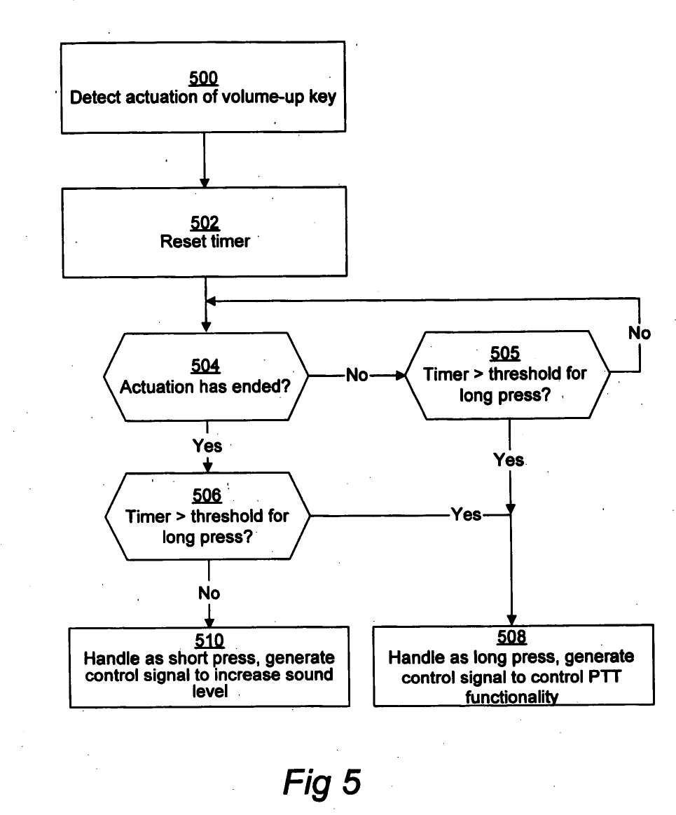

Whether a current actuation of volume-up key 320 is to be processed as a command for sound level control or as a command for controlling push-to-talk functionality is decided by determining whether the volume-up key 320 is actuated during a relatively short time (“short press”) or a relatively long time (“long press”). In one embodiment, the actuation time for volume-up key 320 is classified as long if it exceeds a predetermined time period, and otherwise as short. This procedure will be described in more detail with reference to FIGS. 4 and 5, and this description will also address the internal structure of the mobile terminal 300 not shown in FIG. 3.

Thanks to the elimination of a dedicated push-to-talk key (compared to the prior art terminal 200), there may be space available at the front surface 301_{fs}. Such available space is used, in the exemplifying embodiment of FIG. 3, to accommodate a multi-way input device in the form of a joystick 311. Hence, in this embodiment, valuable design space has been made available and used to further improve the user interface by the addition of a new user interface component without increasing the total available area on the apparatus housing 301. In other embodiments, though, the benefit drawn from the elimination of a dedicated push-to-talk key may instead lie in a reduction in the total available area on the apparatus housing (i.e., a reduction in physical size for the mobile terminal), or in a save in component costs, etc.

The internal component and software structure of the mobile terminal 300 will now be described with reference to FIG. 4. The mobile terminal has a controller 400 which is responsible for the overall operation of the mobile terminal and is preferably implemented by any commercially available CPU (“Central Processing Unit”), DSP (“Digital Signal Processor”) or any other electronic programmable logic device. The controller 400 has associated electronic memory 402 such as RAM memory, ROM memory, EEPROM memory, flash memory, or any combination thereof. The memory 402 is used for various purposes by the controller 400, one of them being for storing data and program instructions for various software in the mobile terminal. The software includes a real-time operating system 420, drivers for a man-machine interface (MMI) 434, an application handler 432 as well as various applications. The applications include a PoC application 450, a conventional GSM/UMTS call handling application 460 as well as various other applications 470, such as a contacts (phonebook) application, a messaging application, a calendar application, a control panel application, a camera application, a mediaplayer, one or more video games, a notepad application, etc.

The MMI 434 also includes one or more hardware controllers; which together with the MMI drivers cooperate with the display 436/303, volume control keys 438/320-322 as well as various other I/O devices such as microphone, speaker, vibrator, keypad, ringtone generator, LED indicator, etc. As is commonly known, the user may operate the mobile terminal through the man-machine interface thus formed.

The software also includes various modules, protocol stacks, drivers, etc., which are commonly designated as 430 and which provide communication services (such as transport, network and connectivity) for an RF interface 406, and optionally a Bluetooth interface 408 and/or an IrDA interface 410. The RF interface 406 comprises an internal or external antenna as well as appropriate radio circuitry for establishing and maintaining a wireless link to a base station (e.g. the link 102 and base station 104 in FIG. 1). As is well known to a man skilled in the art, the radio circuitry comprises a series of analogue and digital electronic components, together forming a radio receiver and transmitter. These components include, i.a., band pass filters, amplifiers, mixers, local oscillators, low pass filters, AD/DA converters, etc.

Hence, the PoC application 450 will get access to the push-to-talk services provided over the wireless packet data network 120 through module 430 and RF interface 406. The blocks 450, 430 and 406, as indicated within a dashed border in FIG. 4, operate in accordance with the afore-described protocol stack 451 to perform the push-to-talk functionality.

The mobile terminal also has a SIM card 404 and an associated reader. As is commonly known, the SIM card 404 comprises a processor as well as local work and data memory.

With reference to FIG. 5, the operation of the mobile terminal 300 to control push-to-talk functionality by detecting actuation of volume-up key 320 will now be described. In FIG. 5, it is assumed that the user has either himself invoked a PTT session, or has been included in such a PTT session by another user. The user may invoke a PTT session by entering the PoC application 450 and selecting the desired other party (individual or group of individuals) in a dedicated list, or selecting such party in a local Contacts database stored in memory 402, etc.

A volume key controller, which is either a separate controller or part of a more general MMI controller in MMI module 434, polls the volume-up key 320 in step 500 and detects that the user has depressed the key. In step 502, a timer is reset and started. In step 504 it is determined whether volume-up key 320 is still depressed. If it is found that the actuation of key 320 has not ended, it is checked in step 505 if the current duration of the actuation, as given by the timer, exceeds a predetermined threshold or time period. In the described embodiment, the predetermined threshold is 400 milliseconds; in other embodiments it may preferably be set to a value between about 100 milliseconds and about 1 second. If the predetermined threshold is exceeded, the execution proceeds to step 508 which is described in more detail below.

If it is determined in step 505 that the current duration of the actuation of volume-up key 320 not yet exceeds the predetermined threshold, the control is returned to step 504 to continue monitoring the actuation of key 320.

If it is found in step 504 that the actuation of volume-up key 320 has in fact ended, it is checked in step 506 if the duration of the now-ended actuation exceeds the predetermined threshold. If so, control is passed to step 508 (this is a rare situation which might occur if the user releases the key 320 almost exactly after the lapse of the predetermined time period). Otherwise, the control is passed to step 510, in which the actuation of volume-up key 320 is handled as a normal short-press for the purpose of volume control. Therefore, a control signal is generated which is forwarded to the appropriate component within MMI module 434, wherein this component will receive the generated control signal and increase the output audio level of e.g. speaker 302 (if not already at maximum level).

In step 508, the actuation of volume-up key 320 is handled as a long-press, as determined in step 505, and a control signal is generated and submitted to PoC application 450 (or subordinate module 430, depending on implementation). The reception of this control signal in PoC application 450 or module 430 represents a situation where the user has been found to command a PTT request “for the floor” to speak or broadcast. Therefore, a request for broadcast status is generated and sent from mobile terminal 300 by module 430 through the digital transceiver formed by the RF interface 406 to the push-to-talk application server 122 over the networks 110, 120.

At the same time, PoC application 450/module 430/RF interface 406 digitizes and packetizes a speech spurt from the user, as picked up by microphone 305, and starts transmitting the speech in PTT VoIP packets 140 to the push-to-talk application server 122 for further forwarding/duplication to the other party/parties 106a-106c that currently has/have receive status.

The volume key controller continues to monitor the volume-up key 320 to detect when the actuation of the volume-up key 320 eventually ends (these steps are not shown in FIG. 5). When this happens, a second control signal is generated and supplied to PoC application 450 or module 430. Upon receipt thereof, a request for receive status is sent to the push-to-talk application server 122, and the transmission of speech in PTT VoIP packets 140 from terminal 100 ends.

The actual recording of speech could start as soon as the user actuates the volume-up key 320 to make sure that nothing of what the user says is lost; it can be difficult for the user to know exactly when to start speaking, if the user has to await the lapse of the 400 millisecond duration and entry into the long-press mode before starting to speak. The mobile terminal will anyway not start sending the recorded speech to the push-to-talk application server 122 before the 400 millisecond duration has lapsed and it is clear that the actuation is in fact a long press intended for PTT functionality. Therefore, there will be a perceivable but short delay in the speech transmission.

In an alternative embodiment, the volume-up key (or volume-down key) is instead used for controlling another speech-related functionality than push-to-talk, such as voice-activated dialing. As is well known per se, voice-activated dialing, or VAD, is a functionality offered in some modern terminals that allows the user to speak the name of a contact stored in the mobile terminal, instead of having to select the contact through the keypad or dial its telephone number manually. A contact record that is to be available for voice-activated dialing includes a prestored voice tag in the form of a short digital audio sequence representing the spoken name. When the user wants to place a telephone call to this contact, he will long-press the volume-up key (or volume-down key) and speak the name of the desired contact into the microphone. VAD functionality in the mobile terminal is actuated by this long-press and operates to match the spoken name with all available prestored voice tags among the contact records. In case of a successful match, the VAD functionality will see to it that a call attempt is initiated to the telephone number associated with the prestored voice tag in the matching contact, and from that on the outgoing call is handled just like any normal outgoing call. The VAD functionality may advantageously be included in the call handling application 460 of FIG. 4.

In still an alternative embodiment, the volume-up key is used for controlling push-to-talk functionality while the volume-down key is used for controlling voice-activated dialing functionality, or vice versa. As with the previously described embodiments, the functionalities are controlled through long-press on the respective keys. Short-press on the volume keys will control the acoustic output level, as has been described above.

The invention has mainly been described above with reference to a few embodiments. However, as is readily appreciated by a person skilled in the art, other embodiments than the ones disclosed above are equally possible within the scope of the invention, as defined by the appended patent claims.

1. A mobile terminal having:
means for providing push-to-talk functionality;
a volume control member; and
a controller associated with said volume control member and adapted to cause a change in an acoustic output level of said mobile terminal in response to a user actuation of said volume control member,
said controller further being adapted to determine whether a duration of said user actuation exceeds a predetermined time period and, in response to said duration exceeding said predetermined time period, to generate a control signal to said means for providing push-to-talk functionality.

2. A mobile terminal as defined in claim 1, wherein said means for providing push-to-talk functionality comprises a wireless transceiver operable in accordance with at least one mobile telecommunications standard such as GSM, UMTS, D-AMPS or CDMA2000.

3. A mobile terminal as defined in claim 1, wherein said means for providing push-to-talk functionality comprises a wireless transceiver operable in a packet-switched communications network such as GPRS.

4. A mobile terminal as defined in claim 1, wherein said means for providing push-to-talk functionality is adapted for voice communication over a data network based on a protocol for packet-switched communication, such as the Internet Protocol (IP).

5. A mobile terminal as defined in claim 1, wherein said volume control member is one of a volume-up key or a volume-down key.

6. A mobile terminal as defined in claim 1, the terminal further having an apparatus housing, wherein said volume control member is located on or at an external surface or said apparatus housing.

7. A mobile terminal as defined in claim 6, said apparatus housing having a front surface which during normal use faces towards a user, and a rear surface which during normal use faces away from said user, wherein said external surface is a long-side surface of said apparatus housing, located between said front and rear surfaces.

8. A mobile terminal as defined in claim 1, wherein said predetermined time period is selected in the range between about 100 milliseconds and about 1 second.

9. A mobile terminal as defined in claim 8, wherein said predetermined time period is about 400 milliseconds.

10. A mobile terminal as defined in claim 3, wherein said means for providing push-to-talk functionality is adapted, when receiving said control signal from said controller, to transmit by said wireless transceiver a request for broadcast status to a remote push-to-talk application server over said packet-switched communications network.

11. A mobile terminal as defined in claim 3, the terminal having an acoustic input device such as a microphone, wherein said means for providing push-to-talk functionality is adapted, when receiving said control signal from said controller, to transmit by said wireless transceiver digitized and packetized speech, as received by said acoustic input device, to a remote push-to-talk application server over said packet-switched communications network.

12. A mobile terminal as defined in claim 1, said controller further being adapted to detect when said user actuation of said volume control member ends and, in response, to generate a second control signal to said means for providing push-to-talk functionality.

13. A mobile terminal as defined in claim 3, wherein said means for providing push-to-talk functionality is adapted, when receiving said second control signal from said controller, to transmit by said wireless transceiver a request for receive status to a remote push-to-talk application server over said packet-switched communications network.

14. A mobile terminal as defined in claim 3, wherein said means for providing push-to-talk functionality is adapted, when receiving said second control signal from said controller, to stop transmitting speech by said wireless transceiver to said remote push-to-talk application server over said packet-switched communications network.

15. A mobile terminal as defined in claim 1, wherein said controller is adapted to cause said change in said acoustic output level of said mobile terminal only if said determined duration of said user actuation does not exceed said predetermined time period.

16. A method of controlling a mobile terminal with push-to-talk functionality, the mobile terminal having a volume control member for controlling an acoustic output level of said mobile terminal, the method involving the steps of:
detecting a user's actuation of said volume control member;
determining whether a duration of said actuation exceeds a predetermined time period;
in response to said duration not exceeding said predetermined time period, generating a control signal for controlling said acoustic output level; and
in response to said duration exceeding said predetermined time period, generating a control signal for controlling said push-to-talk functionality.

17. A method as defined in claim 16, involving the further steps of
receiving said control signal for controlling said push-to-talk functionality, and
transmitting a request for broadcast status to a remote push-to-talk application server over a packet-switched communications network.

18. A method as defined in claim 16, involving the further steps of
receiving said control signal for controlling said push-to-talk functionality,
receiving speech from said user,
digitizing and packetizing said speech, and
transmitting said speech to a remote push-to-talk application server over a packet-switched communications network.

19. A method as defined in claim 16, involving the further steps of
detecting when said actuation of said volume control member ends, and
generating a second control signal for controlling said push-to-talk functionality.

20. A method as defined in claim 19, involving the further steps of
receiving said second control signal, and
transmitting a request for receive status to a remote push-to-talk application server over a packet-switched communications network.

21. A mobile terminal having
means for providing speech-related functionality;
a volume control member; and
a controller associated with said volume control member, said controller being adapted to detect a user actuation of said volume control member and to discriminate between at least a first and a second type of said user actuation, and
said controller further being adapted, in case said user actuation is of said first type, to generate a control signal for controlling said means for providing speech-related functionality, and, in case said user actuation is of said second type, to generate a control signal for controlling an acoustic output level of said mobile terminal.

22. A mobile terminal as defined in claim 1, wherein said controller is adapted to discriminate between said first and said second type of said user actuation by determining whether or not a duration of said user actuation exceeds a predetermined time period.

23. A mobile terminal as defined in claim 21, wherein said means for providing speech-related functionality comprises means for providing push-to-talk functionality.

24. A mobile terminal as defined in claim 21, wherein said means for providing speech-related functionality comprises means for voice-activated dialing (VAD).

25. A mobile terminal as defined in claim 21, wherein said volume control member is one of a volume-up key or a volume-down key.

26. A mobile terminal as defined in claim 21, comprising first and second volume control members in the form of a volume-up key and a volume-down key, or vice versa, wherein said means for providing speech-related functionality comprises first means for providing push-to-talk functionality and second means for voice-activated dialing (VAD), and wherein said controller is adapted, in case said user actuation is of said first type and is made through said first volume control member, to generate said control signal for controlling said first means for providing push-to-talk function-ality, and, in case said user actuation is of said first type and is made through said second volume control member, to generate said control signal for controlling said second means for voice-activated dialing.

27. A mobile terminal as defined in claim 21, wherein said means for providing speech-related functionality comprises a wireless transceiver operable in accordance with at least one mobile telecommunications standard such as GSM, UMTS, D-AMPS or CDMA2000.

28. A method of controlling speech-related functionality of a mobile terminal having a volume control member, the method involving the steps of:
detecting a user actuation of said volume control member;
discriminating between at least a first and a second type of said user actuation;
in case said user actuation is of said first type, controlling said speech-related functionality; and
in case said user actuation is of said second type, controlling an acoustic output level of said mobile terminal.

29. A method as defined in claim 28, wherein said step of discriminating involves determining whether or not a duration of said user actuation exceeds a predetermined time period.

30. A method as defined in claim 28, wherein said speech-related functionality is push-to-talk functionality.

31. A method as defined in claim 28, wherein said speech-related functionality is voice-activated dialing (VAD).

32. A method as defined in claim 28, wherein said volume control member is one of a volume-up key or a volume-down key.

33. A method as defined in claim 28, the mobile terminal comprising first and second volume control members in the form of a volume-up key and a volume-down key, or vice versa, said speech-related functionality including push-to-talk functionality as well as voice-activated dialing (VAD) functionality, the method involving the alternative steps of:
either controlling said push-to-talk functionality, in case said user actuation is of said first type and is made through said first volume control member,
or controlling said voice-activated dialing functionality, in case said user actuation is of said first type and is made through said second volume control member.
